(19) United States
(12) Patent Application Publication
(10) Pub. No.: US 2013/0237359 A1
(43) Pub. Date: Sep. 12, 2013

(54) DRIVING APPARATUS FOR HYBRID VEHICLE

(71) Applicant: SUZUKI MOTOR CORPORATION, Shizuoka-ken (JP)

(72) Inventor: Shumpei Sarashina, Shizuoka-ken (JP)

(73) Assignee: SUZUKI MOTOR CORPORATION, Shizuoka-ken (JP)

(21) Appl. No.: 13/763,224

(22) Filed: Feb. 8, 2013

(30) Foreign Application Priority Data
Mar. 6, 2012 (JP) 2012-048913

(51) Int. Cl. F16H 37/06

(52) U.S. Cl. CPC F16H 37/065
USPC 475/5; 180/65.22; 903/902

(57) ABSTRACT

To provide a driving apparatus for hybrid vehicle for driving an oil pump by a motor generator, which has a configuration such that the revolution of the oil pump can be changed regardless of the running speed of the vehicle, and whereby the drive loss of the oil pump is reduced.

In the case in which four rotating elements T1 to T4 are arranged on a collinear diagram, the rotating elements T1 to T4 are arranged on a straight line, an output shaft 3 of an engine 1 is connected, via a one-way clutch 21, to one T2 of the two rotating elements T2 and T3 arranged in the center of the collinear diagram, an output member 8 is connected to the other T3 of the two rotating elements T2 and T3, two motor generators 5 and 6 are connected to the two rotating elements T1 and T4 arranged at both ends of the collinear diagram, and an oil pump 22 is connected to either one of the two motor generators 5 and 6.

### CROSS-REFERENCE TO RELATED APPLICATIONS

The present application claims priority to Japanese Patent Application No. 2012-048913 filed Mar. 6, 2012, the content of which is incorporated by reference herein in its entirety.

### BACKGROUND OF THE INVENTION

1. Field of the Invention

The present invention relates to a driving apparatus for a hybrid vehicle and, more particularly, relates to a driving apparatus for a hybrid vehicle, in which the revolution of an oil pump can be changed freely without changing the revolution of an output member.

2. Description of Related Art

In recent years, as a vehicle, there has been available a hybrid vehicle provided with a motor generator other than an engine as a driving source in addition to the engine.

In the driving apparatus of this hybrid vehicle, the power generated from the engine and the motor generator is transmitted to driving wheels via a power transmission mechanism.

The power train of a vehicle disclosed in Japanese Patent Application Publication No. JP 2011-37329 includes a power transmission mechanism consisting of an engine, first and second motor generators, and a planetary gear mechanism, and is configured so that the planetary gear mechanism includes three rotating elements consisting of a sun gear, a carrier, and a ring gear, the first motor generator is connected to the sun gear, the engine is connected to the carrier, and an output member for transmitting power to driving wheels and the second motor generator are connected to the ring gear.

A clutch is arranged between the first motor generator and the sun gear, and on the other hand, an oil pump is connected to the first motor generator via a one-way clutch. Thereby, the oil pump is driven by the first motor generator, and the reverse rotation of oil pump is prevented by the one-way clutch.

In the configuration described in JP 2011-37329, the revolution of the first motor generator changes according to the change in revolution of the second motor generator. However, since the second motor generator is connected to the output member, when the revolution of the second motor generator changes, the running speed of the hybrid vehicle also changes.

Therefore, even in the case in which a portion to be lubricated can be lubricated by oil scooped up in the driving apparatus or the like means, the revolution of the oil pump cannot be reduced or stopped, so that there arises a problem that the drive loss of the oil pump increases.

Accordingly, an object of the present invention is to provide a driving apparatus for a hybrid vehicle for driving an oil pump by a motor generator, which has a configuration such that the revolution of the oil pump can be changed regardless of the running speed of vehicle, whereby the drive loss of oil pump is reduced.

### SUMMARY OF THE INVENTION

The present invention provides a driving apparatus for a hybrid vehicle connected to an engine as a driving source, comprising two motor generators, a power transmission mechanism, an output member for transmitting power to driving wheels, and an oil pump, the power transmission mechanism including a first planetary gear mechanism and a second planetary gear mechanism each provided with a sun gear, a pinion gear (planetary gear), a ring gear, and a carrier (planetary carrier) for supporting the pinion gear; wherein any two of the sun gear, ring gear, and carrier of the first planetary gear mechanism and any two of the sun gear, ring gear, and carrier of the second planetary gear mechanism are connected individually to each other, so as to form four rotating elements rotating differentially from each other and being arranged along a straight line on a collinear diagram; the output shaft of the engine is connected, via a one-way clutch, to one of the two rotating elements arranged in the middle of the collinear diagram; the output member is connected to the other of the two rotating elements; and the motor generators are connected to the two rotating elements arranged at both ends of the collinear diagram, the oil pump is connected to either one of the two motor generators.

The present invention concerns a configuration in which the revolution of the oil pump can be changed regardless of the running speed of vehicle, whereby the drive loss of oil pump can be reduced.

### BRIEF DESCRIPTION OF THE DRAWINGS

FIG. 1 is a skeleton diagram of a driving apparatus for a hybrid vehicle in which an oil pump is connected to a first motor generator;

FIG. 2 is a collinear diagram showing the case in which an oil pump is connected to a first motor generator, and the oil pump is not driven (non-operative);

FIG. 3 is a collinear diagram showing the case in which an oil pump is connected to a first motor generator, and the oil pump is driven;

FIG. 4 is a skeleton diagram of a driving apparatus for a hybrid vehicle in which an oil pump is connected to a second motor generator;

FIG. 5 is a collinear diagram showing the case in which an oil pump is connected to a second motor generator, and the oil pump is not driven (non-operative); and

FIG. 6 is a collinear diagram showing the case in which an oil pump is connected to a second motor generator, and the oil pump is driven.

### DETAILED DESCRIPTION

In the present invention, an object such that the configuration is made such that the revolution of an oil pump can be changed regardless of the running speed of vehicle, whereby the drive loss of the oil pump is reduced, which is achieved by connecting the oil pump to either one of two motor generators.

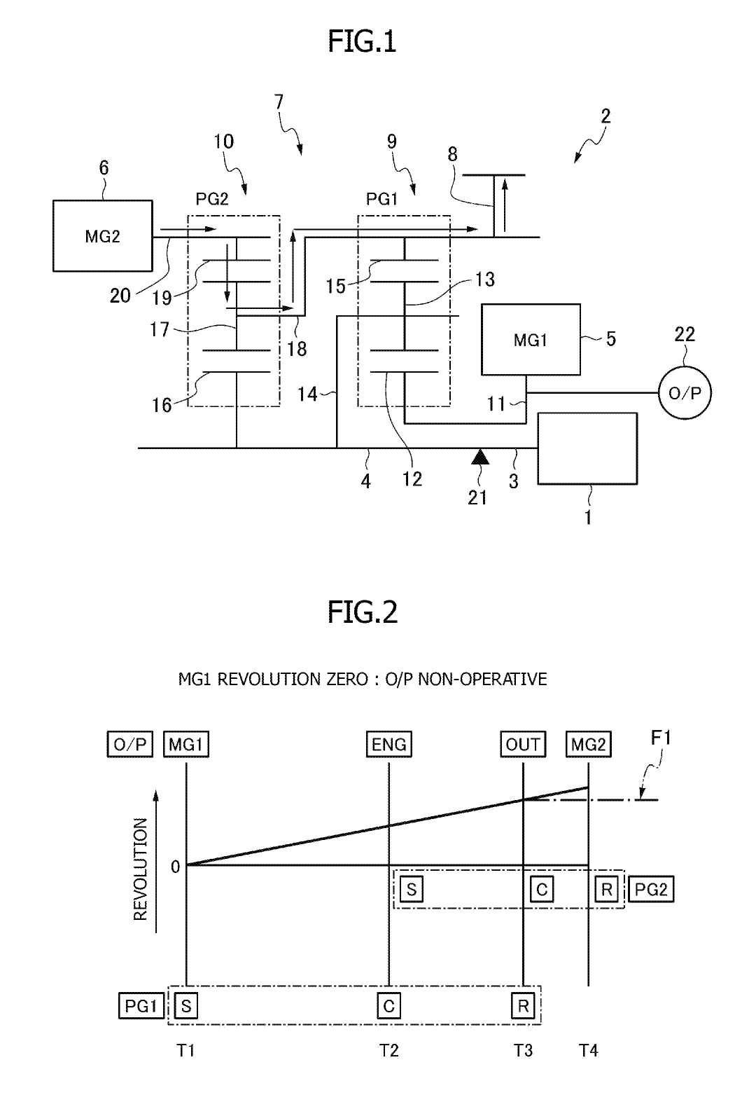

FIGS. 1 to 6 show embodiments of the present invention.

In FIGS. 1 and 4, reference sign 1 denotes an engine that is mounted on a hybrid vehicle to serve as a driving source for delivering torque, and 2 denotes a driving apparatus connected to the engine 1. The engine 1 has an output shaft 3.

The driving apparatus 2 includes an input shaft 4 connected to the output shaft 3 of the engine 1, two motor generators of a first motor generator (mainly for power generation) (described as “MG1” in the figures) 5 and a second motor generator (mainly for driving) (described as “MG2” in the figures) 6, a power transmission mechanism 7, and an output member (described as “OUT” in the figures) 8 for transmitting the power to right and left driving wheels. The revolution of this output member 8 determines the running speed of the hybrid vehicle.

The power transmission mechanism 7 is a so-called combined planetary gear mechanism that is combinedly configured by a first planetary gear mechanism (PG1) 9 and a second planetary gear mechanism (PG2) 10.

The first planetary gear mechanism 9 includes a first sun gear 12 connected to the first motor generator 5 via a first input-side connecting shaft 11, a first pinion gear 13 meshing with this first sun gear 12, a first carrier 14 that supports this first pinion gear 13 and is connected to the input shaft 4, and a first ring gear 15 that meshes with the first pinion gear 13 and is connected to the output member 8.

The second planetary gear mechanism 10 includes a second sun gear 16 connected to the input shaft 4, a second pinion gear 17 meshing with this second sun gear 16, a second carrier 18 that supports this second pinion gear 17 and is connected to the first ring gear 15, and a second ring gear 19 meshing with the second pinion gear 17. This second ring gear 19 connects with the second motor generator 6 via a second input-side connecting shaft 20.

The first planetary gear mechanism 9 and the second planetary gear mechanism 10 have a configuration such that two of the first sun gear 12, the first ring gear 15, and the first carrier 14 constituting the first planetary gear mechanism 9 and two of the second sun gear 16, the second ring gear 19, and the second carrier 18 constituting the second planetary gear mechanism 10 are connected individually to each other, and four rotating elements T1 to T4 rotating differentially each other are formed as shown in FIG. 2.

Specifically, in the first planetary gear mechanism 9 and the second planetary gear mechanism 10, the first carrier 14 and the second sun gear 16 are connected to each other via the input shaft 4, and the second carrier 18 and the first ring gear 15 are connected to each other. In such a configuration, the sun gear 12 forms the first rotating element TI, the first carrier 14 and the second sun gear 16 are connected integrally and forms the second rotating element T2, the first ring gear 15 and the second carrier 18 are connected integrally and forms the third rotating element T3, and the second ring gear 19 forms the fourth rotating element T4.

In this driving apparatus 2, in the case in which the four rotating elements T1 to T4 are arranged in a collinear diagram as shown in FIG. 2, the rotating elements T1 to T4 are arranged on a straight line, the output shaft 3 of the engine 1 is connected to the rotating element T2, which is one of the two rotating elements T2 and T3 arranged in the center of the collinear diagram, via a one-way clutch 21, and the output member 8 is connected to the rotating element T3, which is the other of the two rotating elements T2 and T3. The one-way clutch 21 is arranged between a housing of the driving apparatus 2 and the input shaft 4 to prevent the input shaft 4 from rotating in the direction reverse to the direction of rotation of the output shaft 3 of the engine 1.

Specifically, as described above, the first carrier 14 and the second sun gear 16, which serve as the second rotating element T2, are connected to the output shaft 3 of the engine 1 via the input shaft 4, and the first ring gear 15 and the second carrier 18, which serve as the third rotating element T3, are connected to the output member 8. Also, in the power transmission mechanism 7, to the two rotating elements arranged at both ends on the collinear diagram, the respective motor generators are connected.

Specifically, as described above, the first motor generator 5 is connected to the first sun gear 12, which serves as the first rotating element T1, via the first input-side connecting shaft 11. The second motor generator 6 is connected to the second ring gear 19, which serves as the fourth rotating element T4, via the second input-side connecting shaft 20.

To either one of the first motor generator 5 and the second motor generator 6, for example, as shown in FIG. 1, to the first motor generator 5, an oil pump (described as “O/P” in the figures) 22 is connected via the first input-side connecting shaft 11. This oil pump 22 supplies a lubricating oil to portions requiring lubrication in the driving apparatus 2.

As shown in FIG. 4, the oil pump 22 can be connected, via the second input-side connecting shaft 20, to the second motor generator 6 as either one of the first motor generator 5 and the second motor generator 6.

Therefore, the revolution of the oil pump 22 is changed by the driving state of the first motor generator 5 or the second motor generator 6 regardless of the running speed of the hybrid vehicle corresponding to the revolution of the output member 8.

That is, in this embodiment, without changing the revolution of the third rotating element T3 to which the output member 8 is connected, the revolutions of the other three rotating elements (the first rotating element T1, the second rotating element T2, and the fourth rotating element T3) can be changed.

In the above-described configuration, in the case in which the hybrid vehicle is run by using the engine 1, the first motor generator 5, and the second motor generator 6 in combination, the hybrid vehicle can be run in the state in which the rotation of either one of the first motor generator 5 and the second motor generator 6 is stopped, and the power consumption of the motor generator whose rotation has been stopped is made zero.

At this time, if the first motor generator 5 (or the second motor generator 6) to which the oil pump 22 is connected is stopped, the hybrid vehicle becomes ready to run without being affected by the drive loss of the oil pump 22.

When it becomes necessary to supply a lubricating oil from the oil pump 22, the revolution of the first motor generator 5 (or the second motor generator 6) to which the oil pump 22 is connected has only to be increased.

Therefore, the driving apparatus 2 is configured so that, during the running of the hybrid vehicle, the revolutions of the engine 1 and the first motor generator 5 (or the second motor generator 6) are controlled so that the oil pump 22 and either one of the motor generators 5 and 6 to which the oil pump 22 is connected are stopped without changing the revolution of the output member 8.

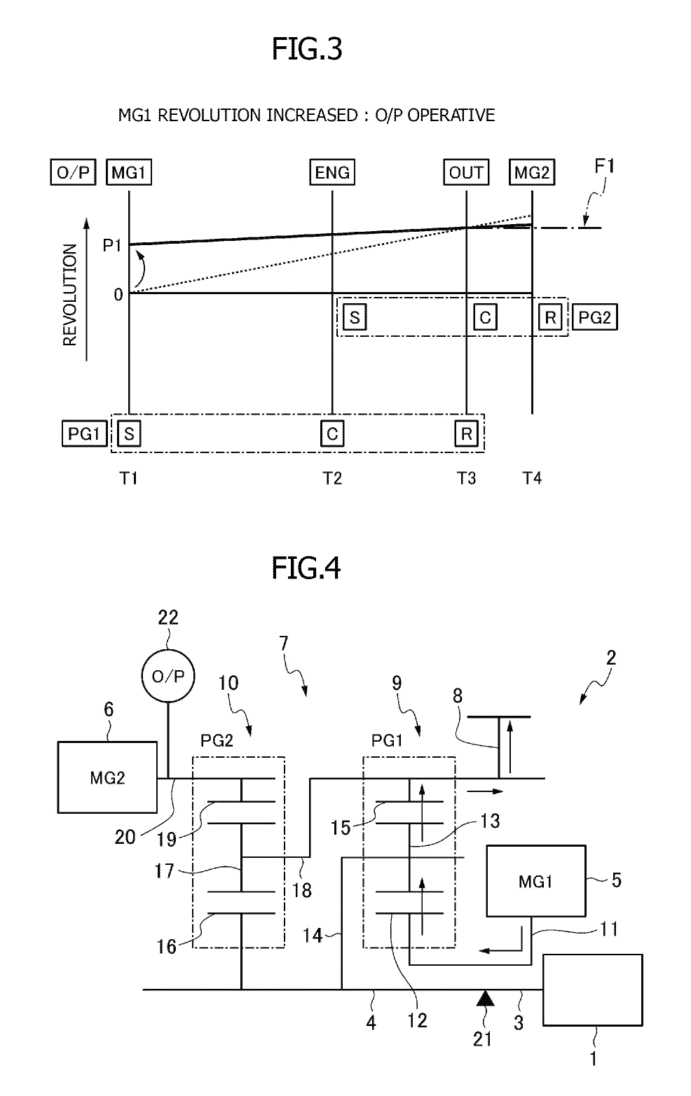

Next, in the driving apparatus 2 shown in FIG. 1, in which the oil pump 22 is connected to the first motor generator 5, the operating state of the oil pump 22 is explained with reference to FIGS. 2 and 3.

FIG. 2 shows the case in which the oil pump 22 is connected to the first motor generator 5, and the hybrid vehicle is run by the driving forces of the engine 1 and the second motor generator 6. In this case, the hybrid vehicle is in a state in which the oil pump 22 need not be driven, and the revolutions of the engine 1 and the second motor generator 6 are regulated so that the rotation of the first motor generator 5 is stopped. The revolution of the output member 8 at this time can be maintained a predetermined value F1.

On the other hand, in the case in which the oil pump 22 needs to be driven, as shown in FIG. 3, if the revolutions of the engine 1 and the second motor generator 6 are increased, the revolution of the first motor generator 5 is increased to P1 while the revolution of the output member 8 is maintained at the predetermined value F1, and the oil pump 22 can be driven.

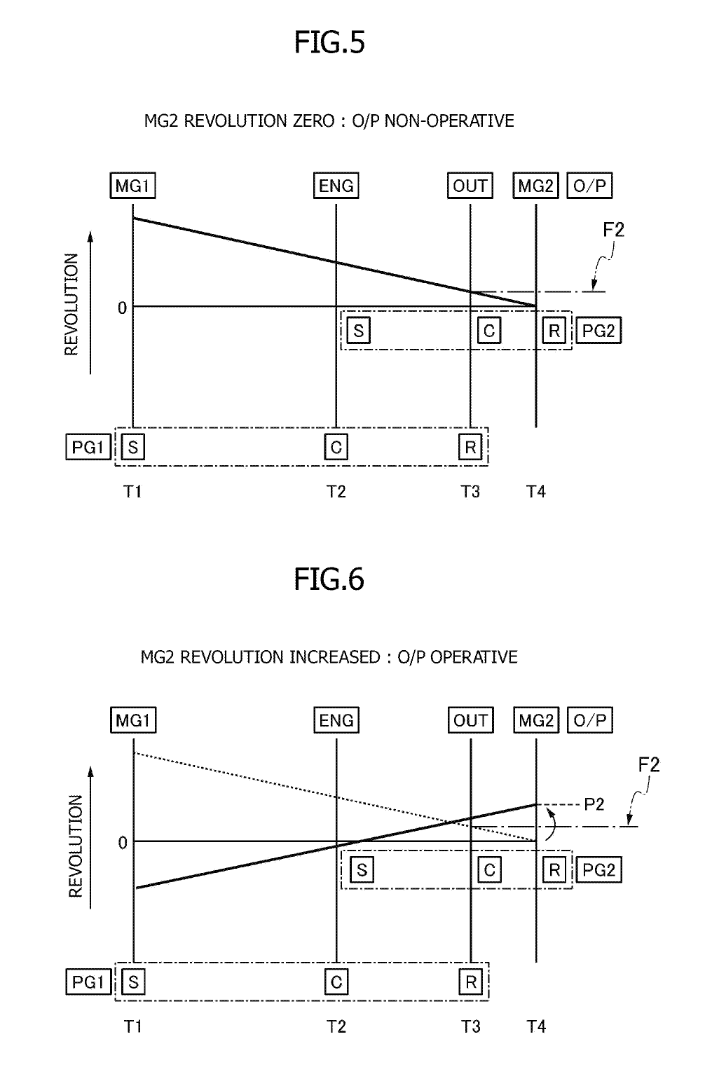

Also, in the driving apparatus 2 shown in FIG. 4, in which the oil pump 22 is connected to the second motor generator 6, the operating state of the oil pump 22 is explained with reference to FIGS. 5 and 6.

FIG. 5 shows the case in which the oil pump 22 is connected to the second motor generator 6, and the hybrid vehicle is run by the driving forces of the engine 1 and the first motor generator 5. In this case, the hybrid vehicle is in a state in which the oil pump 22 need not be driven, and the revolutions of the engine 1 and the first motor generator 5 are regulated so that the rotation of the second motor generator 6 is stopped. The revolution of the output member 8 at this time can be kept at a predetermined value F2.

On the other hand, in the case in which the oil pump 22 needs to be driven, as shown in FIG. 6, if the first motor generator 5 is rotated in the reverse direction, when the rotation of the second motor generator 6 is increased to revolution P2 while the revolution of the output member 8 is maintained at the predetermined value F2, the oil pump 22 is operated to perform lubrication.

The above is an explanation of the embodiment of the present invention. Hereunder, the configuration of the above-described embodiment is explained so as to correspond to the claims.

First, in the invention in accordance with claim 1, in the driving apparatus 2 configured so that the motor generators 5 and 6 are connected to the two rotating elements T1 and T4 arranged at both ends of the collinear diagram, respectively, the oil pump 22 is connected to either one of the motor generators 5 and 6.

Thereby, in the case in which the engine 1, one of the motor generators 5 and 6, and the output member 8 are connected, in the above-described relation, to the power transmission mechanism 7 configured so that the four rotating elements T1 to T4 rotating differentially from each other are arranged on a straight line on the collinear diagram, by changing the revolutions of one of the motor generators 5 and 6 and the engine 1, the revolution of the other of the motor generators can be changed freely without changing the revolution of the output member 8.

Also, considering the above-described state, the oil pump 22 is connected to either one of the motor generators 5 and 6, so that the revolution of the oil pump 22 can be changed freely without changing the revolution of the output member 8. Therefore, the power transmission mechanism 7 can be lubricated by the oil splashed up by the power transmission mechanism 7, and in the case in which the oil pump 22 need not be driven, the revolutions of the motor generator 5 or 6 and the engine 1 are changed to reduce or stop the revolution of the oil pump 22, whereby the drive loss of the oil pump 22 is reduced, and the consumption of fuel and electric power can be reduced.

Furthermore, according to the above-described configuration, the oil pump 22 can be stopped without using a clutch or the like, so that the construction of the driving apparatus 2 can be simplified.

Also, in the invention in accordance with claim 2, during the running of the hybrid vehicle, the revolutions of the engine 1 and the motor generator 5 or 6 are controlled so that the oil pump 22 and the motor generator 5 or 6 to which the oil pump 22 is connected are stopped without changing the revolution of the output member 8.

Thereby, during the running of the hybrid vehicle, the oil pump 22 and the motor generator 5 or 6 to which the oil pump 22 is connected are stopped without changing the revolution of the output member 8, and the drive loss created by the driving of these devices can be reduced.

The driving apparatus in accordance with the present invention can be applied to not only a hybrid vehicle but also any other motor-driven vehicle such as an electric vehicle.

What is claimed is:

1. A driving apparatus for hybrid vehicle connected to an engine as a driving source, comprising:
two motor generators, a power transmission mechanism, an output member for transmitting power to driving wheels, and an oil pump, the power transmission mechanism including a first planetary gear mechanism and a second planetary gear mechanism each provided with a sun gear, a pinion gear, a ring gear, and a carrier for supporting the pinion gear,
wherein any two of the sun gear, ring gear, and carrier of the first planetary gear mechanism and any two of the sun gear, ring gear, and carrier of the second planetary gear mechanism are connected individually to each other, so as to form four rotating elements rotating differentially from each other and being arranged along a straight line on a collinear diagram; the output shaft of the engine is connected, via a one-way clutch, to one of the two rotating elements arranged in the middle of the collinear diagram; the output member is connected to the other of the two rotating elements; and the motor generators are connected to the two rotating elements arranged at both ends of the collinear diagram, the oil pump is connected to either one of the two motor generators.

2. The driving apparatus for hybrid vehicle according to claim 1, wherein during the running of the hybrid vehicle, the revolutions of the engine and the motor generator are controlled so that the oil pump and the motor generator to which the oil pump is connected are stopped without changing the revolution of the output member.
